(19) United States
(12) Patent Application Publication
(10) Pub. No.: US 2026/0030343 A1
(43) Pub. Date: Jan. 29, 2026

(54) Detection of Anomalous Artificial Intelligence Algorithm Weight Patterns

(71) Applicant: MICRO FOCUS LLC, WILMINGTON, DE (US)

(72) Inventors: DOUGLAS MAX GROVER, RIGBY, ID (US); MICHAEL F. ANGELO, HOUSTON, TX (US)

(73) Assignee: MICRO FOCUS LLC, WILMINGTON, DE (US)

(21) Appl. No.: 18/786,169

(22) Filed: Jul. 26, 2024

(51) Int. Cl. G06F 21/54

(52) U.S. Cl. CPC G06F 21/54

(57) ABSTRACT

A weight pattern Artificial Intelligence (AI) algorithm captures, over time, a plurality of instances of weights of an AI algorithm. For example, the weight pattern AI algorithm takes a series of periodic snapshots of the weights of the AI algorithm. The weight pattern AI algorithm learns a normal weight behavior of the AI algorithm based on the captured plurality of instances of weights of the AI algorithm. The weight pattern AI algorithm identifies an anonymous weight pattern of the AI algorithm based on a variance from the normal weight behavior of the AI algorithm. In response to identifying the anomalous weight pattern of the AI algorithm, an action is taken. For example, the action may be to automatically quarantine or unload the AI algorithm.

### FIELD

The disclosure relates generally to Artificial Intelligence (AI) algorithms and particularly to identifying an attack on an AI algorithm based on changes to the AI algorithm's weights.

### BACKGROUND

One of the fundamental aspects of most AI algorithms is weights. For many AI algorithms the weights are generated based on the training/fine-tuning of the AI algorithm. For these types of AI algorithms, weights typically are static and do not change unless the AI algorithm is retrained or fine-tuned. However, there are AI algorithms where the weights are not static and change often. For example, in unsupervised machine learning models, the weights change as the model learns. In addition, some of the next generation neural networks are starting to employ self-learning AI models where the AI model's weights dynamically change.

A subtle way to compromise an AI algorithm is to change the AI algorithm's weights. For example, the article “Sleepy Pickle' Exploit Subtly Poisons ML Models” (https://www.darkreading.com/threat-intelligence/sleepy-pickle-exploit-subtly-poisons-ml-models) discusses where a “Sleepy Pickle” attack may be used to manipulate an AI algorithm's weights to compromise the AI algorithm in different ways, such as biasing the AI algorithm or inserting malicious links in the AI algorithm's output data. Simply looking to see if an AI algorithm's weights have changed to detect that the AI algorithm has been compromised will not work for AI algorithms where the weights are dynamically changing.

### SUMMARY

These and other needs are addressed by the various embodiments and configurations of the present disclosure. The present disclosure can provide a number of advantages depending on the particular configuration. These and other advantages will be apparent from the disclosure contained herein.

A weight pattern Artificial Intelligence (AI) algorithm captures, over time, a plurality of instances of weights of an AI algorithm. For example, the weight pattern AI algorithm takes a series of periodic snapshots of the weights of the AI algorithm. The weight pattern AI algorithm learns a normal weight behavior of the AI algorithm based on the captured plurality of instances of weights of the AI algorithm. The weight pattern AI algorithm identifies an anonymous weight pattern of the AI algorithm based on a variance from the normal weight behavior of the AI algorithm. In response to identifying the anomalous weight pattern of the AI algorithm, an action is taken. For example, the action may be to automatically quarantine or unload the AI algorithm.

The phrases “at least one”, “one or more”, “or,” and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C”, “A, B, and/or C”, and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

The terms “determine,” “calculate” and “compute,” and variations thereof, as used herein, are used interchangeably, and include any type of methodology, process, mathematical operation, or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

### BRIEF DESCRIPTION OF THE DRAWINGS

FIG. 1 is a block diagram of a first illustrative system for detecting anomalous weight patterns.

FIG. 2 is a block diagram of a second illustrative system for training a weight pattern AI algorithm for detecting anomalous weight patterns.

FIG. 3 is a block diagram of a third illustrative system for detecting anomalous weight patterns based on an attack of the AI algorithm.

FIG. 4 is a block diagram of a fourth illustrative system for backing up and restoring weights of an AI algorithm based on an attack of the AI algorithm.

FIG. 5 is a flow diagram of a process for training a weight pattern AI algorithm to identify anomalous weight patterns.

FIG. 6 is a flow diagram of a process for detecting anomalous weight patterns.

FIG. 7 is a flow diagram of a process for detecting anomalous weight patterns based on anomalous input prompts.

FIG. 8 is a flow diagram of a process for identifying an anomalous AI algorithm weight pattern based on a known anomalous AI algorithm weight pattern.

FIG. 9 is a flow diagram of a process for periodically backing up and restoring AI algorithm weights.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

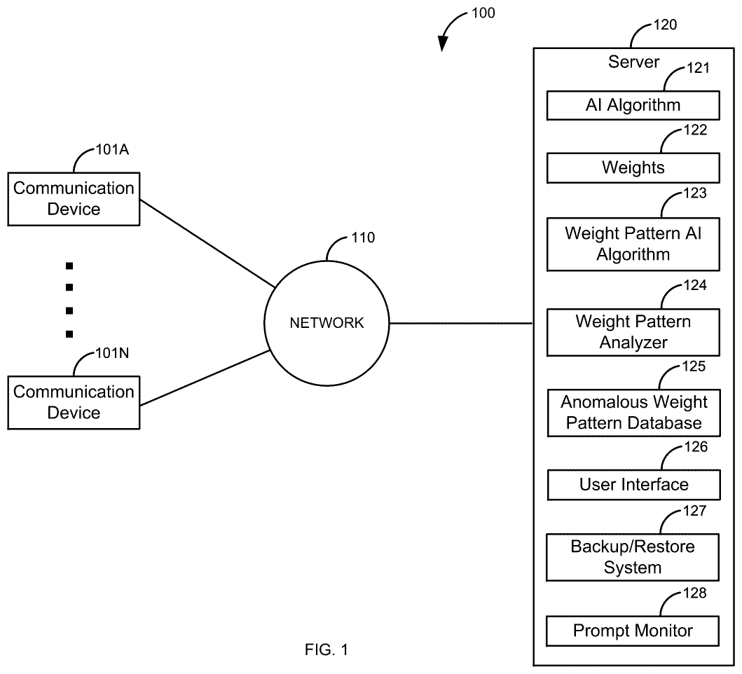

FIG. 1 is a block diagram of a first illustrative system 100 for detecting anomalous weight patterns. The first illustrative system 100 comprises communication devices 101A-101N, a network 110, and a server 120.

The communication devices 101A-101N can be or may include any device that can communicate on the network 110, such as a Personal Computer (PC), a telephone, a video system, a cellular telephone, a Personal Digital Assistant (PDA), a tablet device, a notebook device, a laptop computer, a smartphone, and the like. As shown in FIG. 1, any number of communication devices 101A-101N may be connected to the network 110, including only a single communication device 101. The communication devices 101A-101N are used to access the server 120.

The network 110 can be or may include any collection of communication equipment that can send and receive electronic communications, such as the Internet, a Wide Area Network (WAN), a Local Area Network (LAN), a packet switched network, a circuit switched network, a cellular network, a combination of these, and the like. The network 110 can use a variety of electronic protocols, such as Ethernet, Internet Protocol (IP), Hyper Text Transfer Protocol (HTTP), Web Real-Time Protocol (Web RTC), and/or the like. Thus, the network 110 is an electronic communication network configured to carry messages via packets and/or circuit switched communications.

The server 120 can be any device that can be used to host the AI algorithm 121, such as a cloud service, an application server, a communications server, a networked server, and/or the like. The server 120 further comprises the AI algorithm 121, weights 122, a weight pattern AI algorithm 123, a weight pattern analyzer 124, an anomalous weight pattern database 125, a user interface 126, a backup/restore system 127, and a prompt monitor 128.

The AI algorithm 121 can be any type of AI algorithm 121 that uses weights 122, such as an unsupervised machine learning algorithm, a supervised machine learning algorithm, a semi-supervised machine learning algorithm, a neural network, a generative adversarial network, a generative AI algorithm, a linear regression model, a deep learning algorithm, a natural language processing model, a computer vision model, and/or the like.

The weights 122 are weights 122 that are used by the AI algorithm 121. The weights 122 typically correspond to inputs to each node in the AI algorithm 121. The weights 122 are used by the AI algorithm 121 to generate responses based on input prompts.

The weight pattern AI algorithm 123 is an AI algorithm that can learn over time how the weights 122 of the AI algorithm 121 change under normal conditions. The weight pattern AI algorithm 123 may be an unsupervised machine learning model, a semi-supervised machine learning model, an unsupervised AI model, a neural network, and/or any AI mode that can learn how the weights 122 change during normal operation of the AI algorithm 121.

The weight pattern analyzer 124 can be any hardware/software that can be used to compare an identified anomalous weight patten to a known anomalous weight pattern. The known anomalous weight patterns may have associated information to clarify issues with the different types of anomalous weight pattern. For example, the associated information may describe that the known anomalous weight pattern will bias the AI algorithm 121 in a specific way, such as to generate malicious links, to generate malicious source code, to place malware in the output of the AI algorithm 121, and/or the like.

The anomalous weight pattern database 125 is a database that contains various known anomalous weight patterns that have been learned over time. Although the anomalous weight pattern database 125 is shown on the server 120, the anomalous weight pattern database 125 may reside on the network 110 or be distributed between the server 120 and the network 110.

The user interface 126 is a graphical user interface that is used to manage the AI algorithm 121, the weight pattern AI algorithm 123, the weight pattern analyzer 124, the backup restore system 127 and/or the like. The user interface 126 allows the user to identify any threats based on the AI algorithm 121 being compromised.

The backup/restore system 127 is used to back up and restore the AI algorithm 121/weights 122 in case that the AI algorithm 121/weights 122 have been compromised/damaged. The backup/restore system 127 is managed by the user as part of the backup/restore process.

The prompt monitor 128 is used to monitor input prompts to the AI algorithm 121 to identify potential malicious input prompts that can be used to compromise the AI algorithm 121/weights 122. If an anomalous weight pattern is identified, the prompt monitor 128 can determine if the input prompts are anomalous in comparison to previous/normal input prompts.

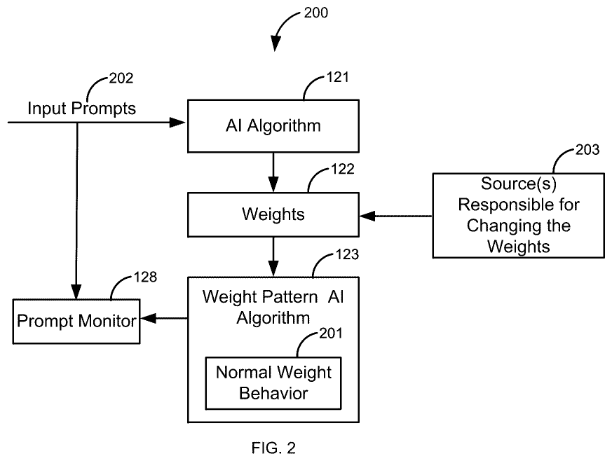

FIG. 2 is a block diagram of a second illustrative system 200 for training a weight pattern AI algorithm 123 for detecting anomalous weight patterns. The second illustrative system 200 comprises the AI algorithm 121, the weights 122, the weight pattern AI algorithm 123, the prompt monitor 128, a normal weight behavior 201, input prompts 202, and source(s) responsible for changing the weights 203.

The idea is to use a weight pattern AI algorithm 123 that monitors the weights 122 of the AI Algorithm 121 to learn how the weights 122 of the AI algorithm 121 and/or the source(s) responsible for changing the weights 203 dynamically change over time. A source responsible for changing the weights 203 is the source code that actually changes each weight 122. For example, the source(s) responsible for changing the weights 203 may be a separate function call of the AI algorithm (or a single one) that changes each individual weight 122. The monitoring of the weights 122/source(s) responsible for changing the weights 203 may be based on a time period, based on a reoccurring event or combination of reoccurring events, based on user input, and/or the like. Thus, the weight pattern AI algorithm 123 captures weights 122/source(s) responsible for changing the weights 203 over time to learn a normal weight behavior 201 of the AI algorithm 121.

The normal weight behavior 201 may be a range of values for the weights 122/individual weights 122, a percentage of change over time of the weights 122/individual weights 122, a change in the weights 122 based on individual input prompts 202/groups of input prompts 202/types of input prompts 202, and/or the like. The normal weight behavior 201 may be used with threshold(s) that define a variance from the normal weight behavior 201. The threshold(s) may be user defined, suggested thresholds, automatically defined thresholds, learned threshold(s), and/or the like. The normal weight behavior 201 may also comprise the source(s) responsible for changing the weights 203.

In addition, the prompt monitor 128 may be used to capture input prompts 202 that are associated with the normal weight behavior 201. The input prompts 202 that arc associated with the normal weight behavior 201 can be used to identify potentially malicious/anomalous input prompts 202 that are being used to bias the AI algorithm 121 to maliciously change the weights 122. For example, for an AI algorithm 121 that dynamically changes the weights 122 based on input prompts 202, the prompt monitor 128 can identify normal input prompts 202 and how the normal input prompts 202 affect the weights 122 of the AI algorithm 121. The normal input prompts 202 are compared to current input prompts 202 when an anomalous weight pattern is identified.

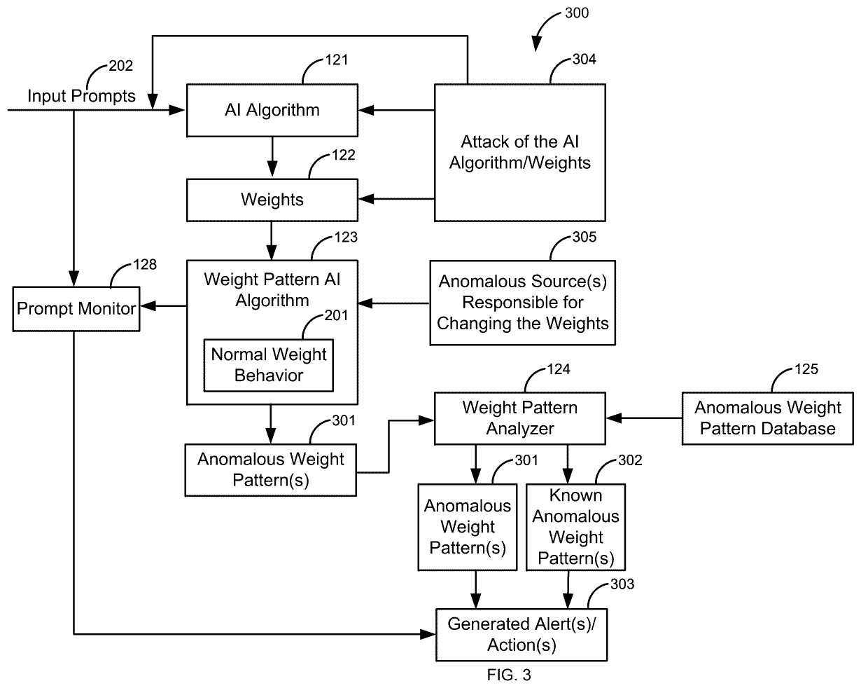

FIG. 3 is a block diagram of a third illustrative system 300 for detecting anomalous weight patterns 301 based on an attack of the AI algorithm 121. The third illustrative system 300 comprises the AI algorithm 121, the weights 122, the weight pattern AI algorithm 123, the weight pattern analyzer 124, the anomalous weight pattern database 125, the prompt monitor 128, the normal weight behavior 201, the input prompts 202, anomalous weight pattern(s) 301, known anomalous weight pattern(s) 302, generated alert(s)/actions 303, an attack of the AI algorithm 121/weights 304, and anomalous source(s) responsible for changing the weights 305.

Once the normal weight behavior 201 (a baseline of weights 122/source(s) responsible for changing the weights 203) is learned by the weight pattern AI algorithm 123, the weight pattern AI algorithm 123 can now detect the anomalous weight patterns 301 and/or the anomalous source(s) responsible for changing the weights 305. The anomalous weight patterns 301 are variations from the normal weight behavior 201 of the AI algorithm 121. The anomalous source(s) responsible for changing the weights 305 are variations from the normal source(s) responsible for changing the weights 203. The variations from the normal weight behavior 201/source(s) responsible for changing the weights 203 may include a percentage of overall change of the weights 122, a change in an individual weight 122 (e.g., where a specific weight never changed before), a change to a group of weights 122, a change based on a number of input prompts 202, a change based on a type of input prompt 202, a slow weight change attack (where the attack occurs over a period of time to try and avoid detection), a new periodic pattern of how individual weights 122 are changed, a new periodic pattern of how a group of specific weights 122 have changed, a different source responsible for changing the weights 203, and/or the like. For example, if a group of ten specific weights 122 changes (with a large delta from the norm), this may be flagged as an anomalous weight pattern 301. The change in weights 122 may include where the AI algorithm 121 has changed and now has additional weights 122 or fewer weights 122 than it had previously. The variation may be based on multiple anomalous weight patterns 301. For example, a specific group of weights 122 may be slowly changing and another group of weights 122 may change dramatically from the norm.

The attack of the AI algorithm 121/weights 304 causes the weights 122 of the AI algorithm 121 to change. The attack of the AI algorithm 121/weights 304 may occur in various ways. For example, the attack of the AI algorithm 121/weights 304 may occur based on a change in the input prompts 202 (which indirectly cause the weights 122 to change), directly changing the weight(s) 122, modifying the AI algorithm 121 (which may cause the AI algorithm 121 to change the weights 122 in an anomalous way), a change in a source(s) responsible for changing the weights 203, and/or the like.

Based on identifying the variance from the normal weight behavior 201, the weight pattern AI algorithm 123 identifies the anomalous weight pattern(s) 301/anomalous sources responsible for changing the weights 305. The anomalous weight pattern(s) 301 and/or anomalous sources responsible for changing the weights 305 are input into the weight pattern analyzer 124. The weight pattern analyzer 124 compares the anomalous weight pattern(s) 301 to the known anomalous weight pattern(s) 302/known anomalous sources responsible for changing the weights that are stored in the anomalous weight pattern database 125. The known anomalous weight pattern(s) 302 and/or known anomalous sources responsible for changing the weights may be associated with a specific type of attack. If there are any match(es), the anomalous weight pattern(s) 301 and/or known anomalous sources responsible for changing the weights can be identified as known malicious weight pattern(s) 302 and/or known anomalous sources responsible for changing the weights in the generated alerts/actions 303. For example, the “Sleepy Pickle” attack described above may have a unique signature of how individual weights 122 are changed. If it is a known type of attack, a security analyst may be provided detailed information about the known attack and how to deal with the known attack. For example, the detailed information may indicate that the attack puts malicious links in the output of the AI algorithm 121. If it is a new anomalous weight pattern 301, the detail information may be to just display information about the changes in weights 122 and how the changes vary from the normal weight behavior 201.

In addition to generating alerts, the system may take specific action. For example, based on a specific known weight pattern 302, the system may automatically unload the AI algorithm 121, quarantine the AI algorithm 121, unload the AI algorithm 121 and reload the weights 122, unload a software application that uses the output of the AI algorithm 122, perform a malware/virus scan, and/or the like.

The prompt monitor 128 may continually monitor the input prompts 202. If an anomalous weight pattern 301 is detected, the prompt monitor 128 can compare the current input prompts 202 to the normal input prompts 202 (e.g., those described in FIG. 2) to see if there is a variance in the current input prompts 202. The variance of input prompts 202 can be an input to the generated alert(s)/action(s) 303 along with the information about the anomalous weight pattern(s) 301/known anomalous weight pattern(s) 302. The input to the generated alert(s)/action(s) 303 may indicate that the current input prompt(s) 202 caused or contributed to the variance from the normal weight behavior 201 of the AI algorithm 121. For example, the user may be alerted that the current input prompts 202 vary from the normal input prompts 202; the alert may indicate that the input prompts 202 are a cause of the variance from the normal weight behavior 201 and that the weight pattern analyzer 124 has identified a known anomalous weight pattern 302 that is associated with similar input prompts 202.

In addition, the detection of anomalous weight patterns 301 may be used where the AI algorithm 121 is continually fine-tuned even though the fine-tuned weights 122 are static. For example, if the AI algorithm 121 is fine-tuned every month, the weight pattern AI algorithm 123 can learn the normal weight behavior 201 of how the monthly fine-tuning affects the weights 122 of the AI algorithm 121. If the AI algorithm 121 is fine-tuned each month based on the input prompts 202, the weight pattern AI algorithm 123 can detect where a group of malicious input prompts 202 are dramatically changing the weights 122 from the norm. A similar process could be used to identify malicious fine-tuning based on a malicious fine-tuning training set that dramatically changes the weights 122 from the normal fine-tuning that that previously occurred.

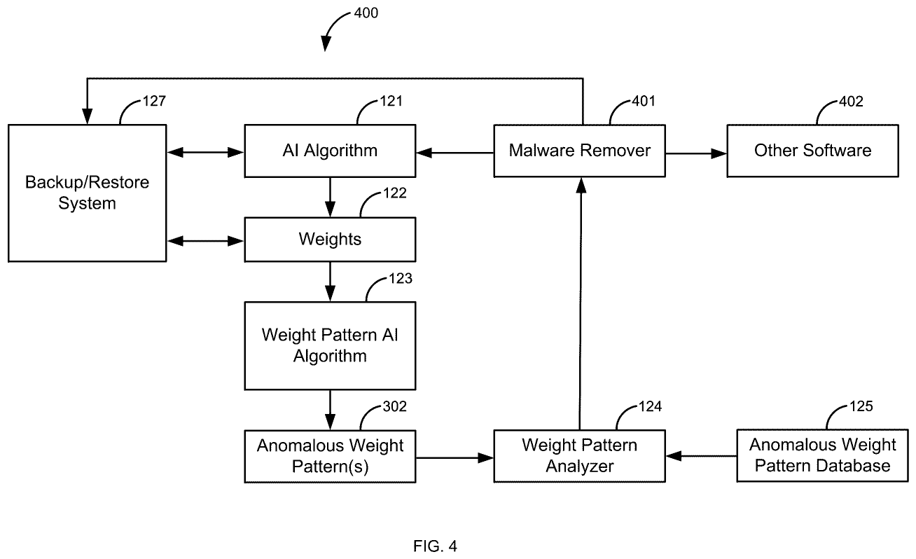

FIG. 4 is a block diagram of a fourth illustrative system 400 for backing up and restoring weights 122 of an AI algorithm 121 based on an attack of the AI algorithm 121. To deal with a compromised AI algorithm 121, the system may periodically backup the AI algorithm 121 and/or the weights 122 of the AI algorithm 121 as shown in FIG. 4.

When the AI algorithm 121 is compromised, the weight pattern analyzer 124 can cause any malware to be removed by a malware remover 401 (either from the AI algorithm 121 or other software 402 external to the AI algorithm 121). The malware remover may remove various types of malware/viruses that are being used to compromise the AI algorithm 121. Information about the type of malware and instructions on how to remove the malware may be stored in the anomalous weight pattern database 125. Based on identification of an anomalous weight pattern 301/known anomalous weight pattern 302, the AI algorithm 121 and/or the weights 122 may then be restored by the backup restore system 127 as part of the backup/restore process. Thus, the legitimate training of the weights 122 before the compromise of the AI algorithm 121 can be restored and not be lost.

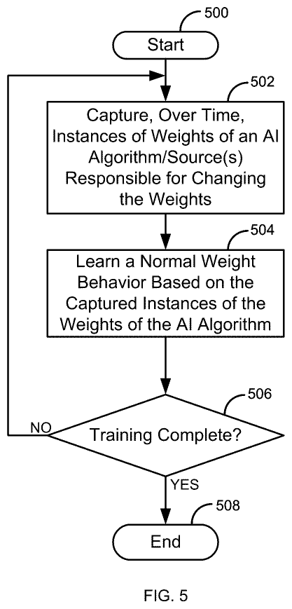

FIG. 5 is a flow diagram of a process for training a weight pattern AI algorithm 123 to identify anomalous weight patterns 301. Illustratively, the communication devices 101A-101N, the server 120, the AI algorithm 121, the weight pattern AI algorithm 123, the weight pattern analyzer 124, the user interface 126, the backup/restore system 127, the prompt monitor 128, the source(s) responsible for changing the weights 203, the anomalous source(s) responsible for changing the weights 305, the malware remover 401, and the other software 402 are stored-program-controlled entities, such as a computer or microprocessor, which performs the method of FIGS. 5-9 and the processes described herein by executing program instructions stored in a computer readable storage medium, such as a memory (i.e., a computer memory, a hard disk, and/or the like). Although the methods described in FIGS. 5-9 are shown in a specific order, one of skill in the art would recognize that the steps in FIGS. 5-9 may be implemented in different orders and/or be implemented in a multi-threaded environment. Moreover, various steps may be omitted or added based on implementation.

The process starts in step 500. The weight pattern AI algorithm 123 (or another process) captures, over time, instances of weighs 122 of the AI algorithm 121 in step 502. For example, the weight pattern AI algorithm 123 may periodically (e.g., every hour) capture the weights 122 of the AI algorithm 121. Each instance of the weights 122 is a snapshot of the weights 122 at a given point in time.

In addition, the weight pattern AI algorithm 123 can identify the sources that are responsible for changing the weight(s) 203 in step 502. A source that is responsible for changing the weight(s) 203 is typically source code of the AI algorithm 121. For example, the source code that is responsible for changing the weight(s) 203 may be a series of function call(s) of the AI algorithm.

The weight pattern AI algorithm 123 learns, in step 504, the normal weight behavior 201 based on the captured instances of the weights 122 of the AI algorithm 121. For example, the weight pattern AI algorithm 123 may be an unsupervised machine learning algorithm that learns over time by periodically sampling the weights 122 to determine the normal weight behavior 201. The learning may also include the identified sources that are responsible for changing the weight(s) 203 of the AI algorithm 121. For example, the normal behavior may be that each specific weight 122 of the AI algorithm 121 are changed with a specific function call.

The weight pattern AI algorithm 123 determines, in step 506, if the training is complete. For example, a user may instruct the weight pattern AI algorithm 123 to stop training the weight pattern AI algorithm 123 in step 506. If the training of the AI weight pattern AI algorithm 123 is not complete in step 506, the process goes back to step 502. Otherwise, if the training is complete in step 506, the process ends in step 508.

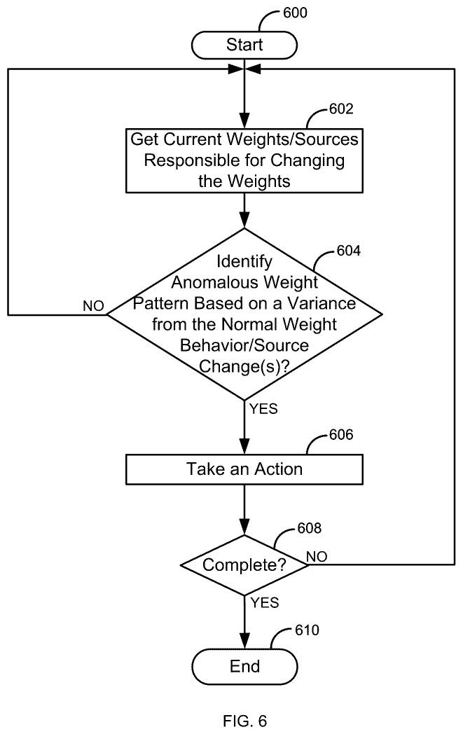

FIG. 6 is a flow diagram of a process for detecting anomalous weight patterns 301. The process starts in step 600. The weight pattern AI algorithm 123, in step 602, gets the current weights 122 of the AI algorithm 121. The current weights may be captured in real-time (e.g., while the AI algorithm 121 is running), semi-real-time, and/or the like. In addition, the weight pattern AI algorithm 123 may also capture the anomalous sources of the responsible for changing the weights 305. For example, the anomalous source responsible for changing different weight 305 may now be a different function call than is normally used (e.g., a malware is now changing the weights 122 or an external source is changing the weights 122).

The weight pattern AI algorithm 123 determines if an anomalous weight pattern 301 based on a variance from the normal weight behavior 201/and or the anomalous source responsible for changing the weights 305 has been identified in step 604. If an anomalous weight pattern 301 has not been identified and the anomalous source(s) responsible for changing the weights 305 have not been identified in step 604, the process goes back to step 602. Otherwise, if an anomalous weight pattern 301 based on the variance from the normal weight behavior 201 and/or the anomalous source(s) responsible for changing the weights 305 has been identified in step 604, an action is taken in step 606. For example, a user may be notified of the anomalous weight pattern 301 and/or the change in the source(s) responsible for changing the weights 203.

The process determines, in step 608, if the process is complete. If the process is not complete in step 608, the process goes back to step 602. Otherwise, the process ends in step 610.

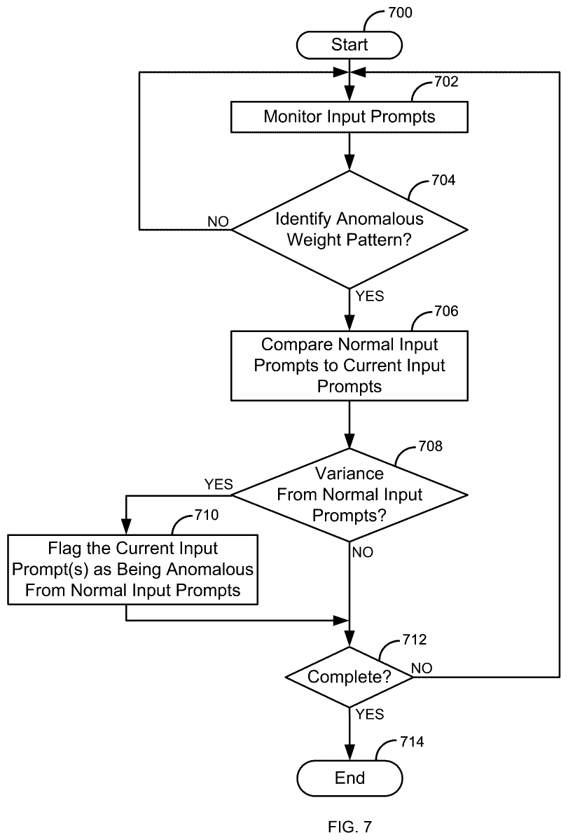

FIG. 7 is a flow diagram of a process for detecting anomalous weight patterns 301 based on anomalous input prompts 202. The process starts in step 700. The prompt monitor 128 monitors the input prompts 202 in step 702. The prompt monitor 128, waits, in step 704, for weight pattern AI algorithm 123 to identify an anomalous weight pattern 301. If an anomalous weight pattern 301 has not been identified in step 704, the process goes back to step 702.

Otherwise, if an anomalous weight pattern 301 has been identified in step 704, the prompt monitor 128 compares the normal input prompts 202 (the input prompts 202 that were part of the training process) to the current input prompts 202 in step 706. The prompt monitor 128 determines, in step 708, if there is a variance from the normal input prompts 202. If there is a variance in step 708, the prompt monitor 128 flags the input prompt(s) 202 as being anomalous as compared to the normal input prompts 202 in step 710 and the process goes to step 712. If there is no variance from the normal input prompts 202 in step 708, the process goes to step 712.

The process determines, in step 712, if the process is complete. If the process is not complete in step 712, the process goes to step 702. Otherwise, the process ends in step 714.

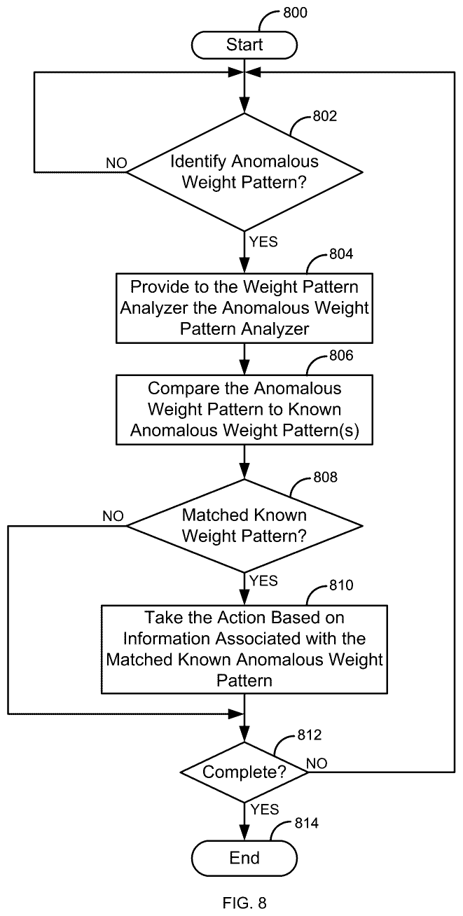

FIG. 8 is a flow diagram of a process for identifying an anomalous weight pattern 301 based on a known anomalous AI algorithm weight pattern 302. The process starts in step 800. The weight pattern AI algorithm 123, waits, in step 802, to identify an anomalous weight pattern 301. If an anomalous weight pattern 301 has not been identified in step 802, the process of step 802 repeats.

Otherwise, if an anomalous weight pattern 301 has been identified in step 802, the weight pattern AI algorithm 123 provides, in step 804, to the weight pattern analyzer 124 the identified anomalous weight pattern 301. The weight pattern analyzer 124 compares, in step 806, the anomalous weight pattern 301 to the known anomalous weight pattern(s) 302 in the anomalous weight pattern database 125. If there is a matched known weight pattern 302 (e.g., one that is the same or similar), in step 808, the weight pattern analyzer 124 takes an action based on information associated with the matched known anomalous weight pattern 302 in step 810. For example, the weight pattern analyzer 124 may remove malware that is causing the known weight pattern 302. The process then goes to step 812. Otherwise, if there are not any matched known weight anomalous pattern(s) 302 in step 808, the process goes to step 812.

The process determines, in step 812, if the process is complete. If the process is not complete in step 812, the process goes back to step 802. Otherwise, the process ends in step 814.

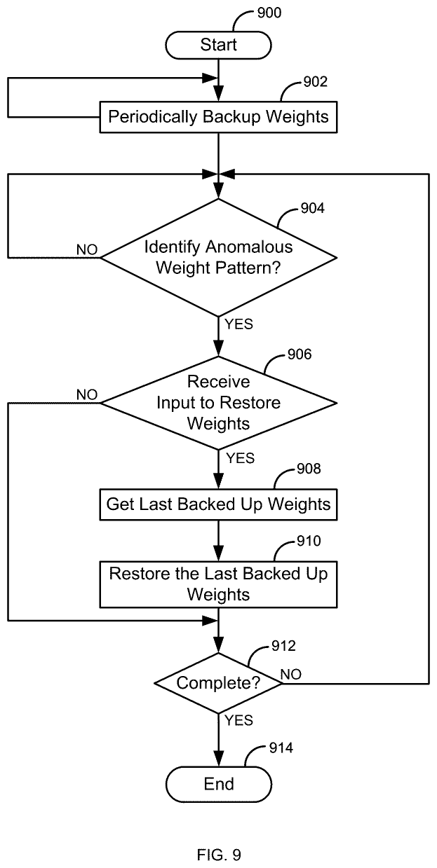

FIG. 9 is a flow diagram of a process for periodically backing up and restoring AI algorithm weights 122. The process starts in step 900. The backup/restore system 127 periodically backs up the weights 122 in step 902. In addition, the backup/restore system 127 may also backup the AI algorithm 121 in step 902. Step 902 may run on a separate thread.

The weight pattern AI algorithm 123 waits, in step 904 to identify an anomalous weight pattern 301. If an anomalous weight pattern 301 is not identified in step 904, the process of step 904 repeats. Otherwise, if an anomalous weight pattern 301 has been identified in step 904, the process waits, in step 906, to receive input to restore the weights 122. For example, the input may be from a user. Alternatively, step 906 may occur without user input and occur automatically. If there is not user input received in step 906, the process goes to step 912. Otherwise, if there is user input received in step 906, the backup/restore system 127 gets the last backed up weights 122 in step 908. The backup/restore system 127 restores the last backed up weights 122 in step 910 and the process goes to step 912. In addition, the AI algorithm 121 may also be restored, in step 910, the AI algorithm 121 (if the AI algorithm 121 has been compromised).

The process determines, in step 912, if the process is complete. If the process is not complete in step 912, the process goes back to step 904. Otherwise, the process ends in step 914.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

Any of the steps, functions, and operations discussed herein can be performed continuously and automatically.

However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should however be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosure.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, sub combinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving case and\or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A system comprising:
a microprocessor; and
a computer readable medium, coupled with the microprocessor and comprising microprocessor readable and executable instructions that, when executed by the microprocessor, cause the microprocessor to:
capture, over time, a plurality of instances of weights of an AI algorithm;
learn a normal weight behavior of the AI algorithm based on the captured plurality of instances of weights of the AI algorithm;
identify an anonymous weight pattern of the AI algorithm based on a variance from the normal weight behavior of the AI algorithm; and
in response to identifying the anomalous weight pattern of the AI algorithm, take an action.

2. The system of claim 1, wherein the variance from the normal weight behavior of the AI algorithm is based on at least one of: a percentage of overall change of the weights of the AI algorithm, a change in an individual weight of the AI algorithm, a change to a group of weights of the AI algorithm, a change based on a number of input prompts, a change based on a type of input prompt, a slow weight change attack, a new periodic pattern of how individual weights of the AI algorithm are changed, a new periodic pattern of how a group of specific weights of the AI algorithm have changed, and a change in a number of weights of the AI algorithm.

3. The system of claim 2, wherein the variance from the normal weight behavior of the AI algorithm is based on at least one of: the change based on the number of input prompts and the change based on the type of input prompt.

4. The system of claim 2, wherein the variance from the normal weight behavior of the AI algorithm is based on at least one of: the new periodic pattern of how individual weights of the AI algorithm are changed and the new periodic pattern of how the group of specific weights of the AI algorithm have changed.

5. The system of claim 1, wherein the microprocessor readable and executable instructions further cause the microprocessor to:
provide, to a weight pattern analyzer, the anomalous weight pattern of the AI algorithm;
compare, by the weight pattern analyzer, the anomalous weight pattern of the AI algorithm to one or more known anomalous weight patterns; and
determine that the anomalous weight pattern of the AI algorithm is the same or similar to one of the one or more known anonymous weight patterns, wherein the action is based on information associated with the one of the one or more known anonymous weight patterns.

6. The system of claim 1, wherein capturing, over time, the weights of AI algorithm is based on a plurality of fine-tuning of the AI algorithm.

7. The system of claim 1, wherein the microprocessor readable and executable instructions further cause the microprocessor to:
periodically backup the weights of the AI algorithm;
in response to identifying the anomalous weight pattern of the AI algorithm, identify a last backed up weights; and
restore the weights of the AI algorithm using last backed up weights.

8. The system of claim 1, wherein identifying the anonymous weight pattern of the AI algorithm based on the variance from the normal weight behavior of the AI algorithm is also based on monitoring current input prompts to the AI algorithm to determine if the current input prompts to the AI algorithm caused or contributed to the variance from the normal weight behavior of the AI algorithm.

9. The system of claim 1, wherein the variance of the normal weight behavior is identified based on one or more of: a range of values for one or more weights of the AI algorithm, a percentage of change over time for the one or more of the weights of the AI algorithm, a change in the one or more of the weights of the AI algorithm based on one or more input prompts, and a change in the one or more weights of the AI algorithm based on a type of input prompt.

10. The system of claim 1, wherein learning the normal weight behavior of the AI algorithm based on the captured plurality of instances of weights of the AI algorithm further comprises identifying an anomalous source responsible for changing one or more weights of the AI algorithm.

11. A method comprising:
capturing, over time, by a weight pattern Artificial Intelligence (AI) algorithm, a plurality of instances of weights of an AI algorithm;
learning, by the weight pattern AI algorithm, a normal weight behavior of the AI algorithm based on the captured plurality of instances of weights of the AI algorithm;
identifying, by the weight pattern AI algorithm, an anonymous weight pattern of the AI algorithm based on a variance from the normal weight behavior of the AI algorithm; and
in response to identifying the anomalous weight pattern of the AI algorithm, taking an action.

12. The method of claim 11, wherein the variance from the normal weight behavior of the AI algorithm is based on at least one of: a percentage of overall change of the weights of the AI algorithm, a change in an individual weight of the AI algorithm, a change to a group of weights of the AI algorithm, a change based on a number of input prompts, a change based on a type of input prompt, a slow weight change attack, a new periodic pattern of how individual weights of the AI algorithm are changed, a new periodic pattern of how a group of specific weights of the AI algorithm have changed, and a change in a number of weights of the AI algorithm.

13. The method of claim 12, wherein the variance from the normal weight behavior of the AI algorithm is based on at least one of: the change based on the number of input prompts and the change based on the type of input prompt.

14. The method of claim 12, wherein the variance from the normal weight behavior of the AI algorithm is based on at least one of: the new periodic pattern of how individual weights of the AI algorithm are changed and the new periodic pattern of how the group of specific weights of the AI algorithm have changed.

15. The method of claim 11, further comprising:
providing, to a weight pattern analyzer, the anomalous weight pattern of the AI algorithm;
comparing, by the weight pattern analyzer, the anomalous weight pattern of the AI algorithm to one or more known anomalous weight patterns; and
determining that the anomalous weight pattern of the AI algorithm is the same or similar to one of the one or more known anonymous weight patterns, wherein the action is based on information associated with the one of the one or more known anonymous weight patterns.

16. The method of claim 11, wherein capturing, over time, the weights of AI algorithm is based on a plurality of fine-tuning of the AI algorithm.

17. The method of claim 11, further comprising:
periodically backing up the weights of the AI algorithm;
in response to identifying the anomalous weight pattern of the AI algorithm, identifying a last backed up weights; and
restoring the weights of the AI algorithm using the last backed up weights.

18. The method of claim 11, wherein identifying the anonymous weight pattern of the AI algorithm based on the variance from the normal weight behavior of the AI algorithm is also based on monitoring current input prompts to the AI algorithm to determine if the current input prompts to the AI algorithm caused or contributed to the variance from the normal weight behavior of the AI algorithm.

19. The method of claim 11, wherein the variance of the normal weight behavior is identified based on one or more of: a range of values for one or more weights of the AI algorithm, a percentage of change over time for the one or more of the weights of the AI algorithm, a change in the one or more of the weights of the AI algorithm based on one or more input prompts, and a change in the one or more weights of the AI algorithm based on a type of input prompt.

20. A non-transient computer readable medium having stored thereon instructions that cause a microprocessor to execute a method, the method comprising instructions to:
capture, over time, a plurality of instances of weights of an AI algorithm;
learn a normal weight behavior of the AI algorithm based on the captured plurality of instances of weights of the AI algorithm;
identify an anonymous weight pattern of the AI algorithm based on a variance from the normal weight behavior of the AI algorithm; and
in response to identifying the anomalous weight pattern of the AI algorithm, take an action.
